(19) United States
(12) Patent Application Publication
(10) Pub. No.: US 2026/0038098 A1
(43) Pub. Date: Feb. 5, 2026

(54) IMAGE PROCESSING APPARATUS AND METHOD

(71) Applicant: HANWHA VISION CO., LTD., Seongnam-si (KR)

(72) Inventor: Youn Man HAN, Seongnam-si (KR)

(73) Assignee: HANWHA VISION CO., LTD., Seongnam-si (KR)

(21) Appl. No.: 19/286,633

(22) Filed: Jul. 31, 2025

(30) Foreign Application Priority Data
Aug. 2, 2024 (KR) 10-2024-0103259

(51) Int. Cl. G06T 5/73; G06T 5/50

(52) U.S. Cl. CPC G06T 5/73; G06T 5/50; G06T 2207/20192

(57) ABSTRACT

An image processing apparatus includes an input device configured to receive an image, an image processor configured to enhance a sharpness of the image, and an output device configured to output the image with the enhanced sharpness, where the image processor is further configured to determine a weight of a gain for each pixel included in an edge area of the image based on a similarity between each pixel and adjacent pixels and apply a modified gain, which reflects the determined weight, to each pixel included in the edge area of the image.

### CROSS-REFERENCE TO RELATED APPLICATIONS

This application is based on and claims priority to Korean Patent Application No. 10-2024-0103259, filed on Aug. 2, 2024, in the Korean Intellectual Property Office, the disclosure of which is incorporated by reference herein in its entirety.

### BACKGROUND

### 1. Field

The disclosure relates to an image processing apparatus and method, and more particularly, to an image processing apparatus and method which adjust a weight of a gain for edge sharpening by referring to the similarity between each pixel and its surrounding pixels.

### 2. Description of Related Art

An edge sharpening technique may be used to clearly recognize an object included in an image. Through the edge sharpening technique, a boundary between an object and a background may be made clear, or a boundary between different patterns may be made clear.

For the edge sharpening technique, a certain gain may be applied to pixels corresponding to a boundary.

If noise is contained in the image, the noise may be recognized as a boundary. In this case, the gain may be applied to the noise, thereby amplifying the noise.

Therefore, a process that prevents the amplification of noise even when the edge sharpening technique is applied to an image is needed.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide an image processing apparatus and method which adjust a weight of a gain for edge sharpening by referring to the similarity between each pixel and its surrounding pixels.

Additional aspects will be set forth in part in the description which follows and, in part, will be apparent from the description, or may be learned by practice of the presented embodiments.

According to an aspect of an example embodiment, an image processing apparatus may include an input device configured to receive an image, an image processor configured to enhance a sharpness of the image, and an output device configured to output the image with the enhanced sharpness, where the image processor is further configured to determine a weight of a gain for each pixel included in an edge area of the image based on a similarity between each pixel and adjacent pixels and apply a modified gain, which reflects the determined weight, to each pixel included in the edge area of the image.

The weight of the gain for each pixel may be determined as a larger value as the similarity between each pixel and the adjacent pixels increases.

The weight of the gain for each pixel may be determined as a larger value as a complexity of a pixel area comprising each pixel and the adjacent pixels decreases.

The image processor may be further configured to remove noise from the image with the enhanced sharpness using a band-pass filter.

The modified gain may be determined by applying the determined weight to a preset reference gain.

The edge area may be determined by subtracting an original image from a blurred image that is obtained by blurring the original image.

The image processor may be further configured to determine the weight of the gain for each pixel based on a pixel distribution.

The weight of the gain for each pixel may be determined as a larger value as a complexity of a pixel area comprising each pixel and the adjacent pixels decreases.

According to an aspect of an example embodiment, an image processing method may include receiving an image, enhancing a sharpness of the image, and outputting the image with the enhanced sharpness, where the enhancing of the sharpness of the image may include determining a weight of a gain for each pixel included in an edge area of the image based on a similarity between each pixel and adjacent pixels and applying a modified gain, which reflects the determined weight, to each pixel included in the edge area of the image.

The weight of the gain for each pixel may be determined as a larger value as the similarity between each pixel and the adjacent pixels increases.

The weight of the gain for each pixel may be determined as a larger value as a complexity of a pixel area comprising each pixel and the adjacent pixels decreases.

The method may include removing noise from the image with the enhanced sharpness by using a band-pass filter.

The modified gain may be determined by applying the determined weight to a preset reference gain.

The edge area may be determined by subtracting an original image from a blurred image obtained by blurring the original image.

The weight of the gain for each pixel may be determined based on a pixel distribution.

The weight of the gain for each pixel may be determined as a larger value as a complexity of a pixel area comprising each pixel and the adjacent pixels decreases.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram of a surveillance system according to one or more embodiments;

FIG. 2 is a block diagram of an image processing apparatus according to one or more embodiments;

FIG. 3 is a block diagram of an image processor shown in FIG. 2 according to one or more embodiments;

FIG. 4 is a diagram of an image according to one or more embodiments;

FIG. 5 is a diagram of a blurred image obtained by blurring the image of FIG. 4 according to one or more embodiments;

FIG. 6 is a diagram illustrating a difference between the image of FIG. 4 and the blurred image of FIG. 5 according to one or more embodiments;

FIG. 7 is a diagram illustrating the generation of an image with enhanced sharpness according to one or more embodiments;

FIG. 8 is a diagram illustrating the scanning of an image using a mask according to one or more embodiments;

FIG. 9 is a diagram of a mask according to one or more embodiments;

FIG. 10 is a diagram of a weight table according to one or more embodiments;

FIG. 11 is a graph illustrating the relationship between similarity and weight according to one or more embodiments; and

FIG. 12 is a graph illustrating the relationship between pixel distribution and similarity according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Terms such as first, second, etc. may be used to describe various components, but are used only for the purpose of distinguishing one component from another component. These terms do not limit the difference in the material or structure of the components.

The terms of a singular form may include plural forms unless otherwise specified. In addition, when a certain part “includes” a certain component, it means that other components may be further included rather than excluding other components unless otherwise stated.

In addition, terms such as “unit” and “module” described in the specification may indicate a unit that processes at least one function or operation, and this may be implemented as hardware or software, or may be implemented as a combination of hardware and software.

The use of the term “the” and similar designating terms may correspond to both the singular and the plural.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

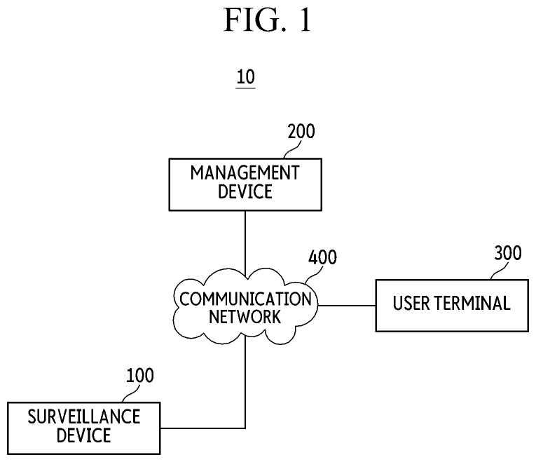

FIG. 1 is a diagram of a surveillance system 10 according to one or more embodiments.

Referring to FIG. 1, the surveillance system 10 includes a surveillance device 100, a management device 200, a user terminal 300, and a communication network 400.

The surveillance device 100 may photograph a surveillance area and generate an image as a result of the photographing. For example, the surveillance device 100 may be provided in the form of a camera. The image generated by the surveillance device 100 may be a still image or a moving image.

The communication network 400 may provide a communication path between the surveillance device 100 and the management device 200. For example, the communication network 400 may perform communication between the surveillance device 100 and the management device 200 by including at least one of a wired network and a wireless network.

The image generated by the surveillance device 100 may be transmitted to the management device 200. The management device 200 may store the image received from the surveillance device 100 and transmit the stored image to a user. For example, the management device 200 may be a video management system (VMS), a network video recorder (NVR) or a digital video recorder (DVR) or may include at least one of them.

The surveillance system 10 may include one or more surveillance devices 100. The management device 200 may store images received from the surveillance devices 100 and provide the stored images to the user.

The user terminal 300 may connect to the management device 200 and output images captured by the surveillance devices 100. The user may check surveillance results for the surveillance area using the images output from the user terminal 300. In addition, the user terminal 300 may transmit a control command to the surveillance devices 100. The control command may be a command for controlling the pan, tilt, or zoom of the surveillance devices 100 and may be a command for starting or ending photographing.

If an image generated by a surveillance device 100 is not clear, surveillance through the image may not be easily performed. At least one of the surveillance devices 100, the management device 200, and the user terminal 300 may include an image processing apparatus 500 which will be described later. The image processing apparatus 500 may enhance the sharpness of an input image and output the image with the enhanced sharpness. If the image processing apparatus 500 is included in a surveillance device 100, the surveillance device 100 may transmit a captured image to the management device 200 after enhancing the sharpness of the captured image. If the image processing apparatus 500 is included in the management device 200, the management device 200 may transmit an image received from a surveillance device 100 to the user terminal 300 after enhancing the sharpness of the image. If the image processing apparatus 500 is included in the user terminal 300, the user terminal 300 may display an image received from the management device 200 after enhancing the sharpness of the image.

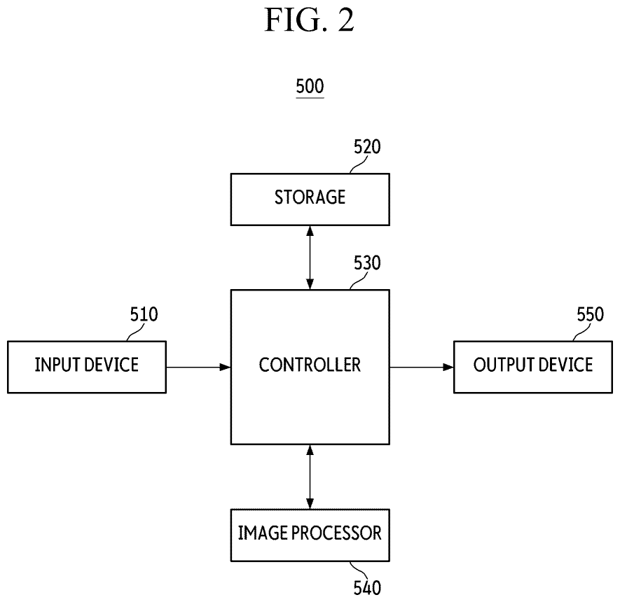

FIG. 2 is a block diagram of an image processing apparatus 500 according to one or more embodiments.

Referring to FIG. 2, the image processing apparatus 500 according to one or more embodiments of the present disclosure includes an input device 510, a storage 520, a controller 530, an image processor 540, and an output device 550.

The input device 510 may receive an image. The image input to the input device 510 may be an image that has not been processed for sharpness enhancement. Hereinafter, an original image refers to an image input to the input device 510 that has not been processed for sharpness enhancement. The input device 510 may include a camera or a surveillance camera including an image capturing module such as a complementary metal-oxide-semiconductor (CMOS) image sensor or a charge-coupled device (CCD), not being limited thereto. The input device 510 may also include a touch sensor, a keyboard, a mouse, a microphone, etc. The output device 550 may include at least one display such as liquid crystal display (LCD), a light-emitting diode (LED) display, an organic LED (OLED), a speaker, etc. The image processor 540 may include at least one digital signal processor (DSP), not being limited thereto.

The storage 520 may temporarily or permanently store an image input through the input device 510. In addition, the storage 520 may temporarily or permanently store an image generated by the image processor 540. In addition, the storage 520 may store information and data necessary for the operation of the image processing apparatus 500.

The image processor 540 may enhance the sharpness of an image. To this end, the image processor 540 may determine a weight of a gain for each pixel included in an edge area of the image by referring to (e.g., based on) the similarity between each pixel and adjacent pixels and may apply the gain, which reflects the previously determined weight, to each pixel included in the edge area of the image. Specifically, the image processor 540 may first detect an edge area of an image in order to enhance the sharpness of the image. Then, the image processor 540 may apply a gain to the edge area and synthesize the edge area, to which the gain has been applied, and the original image to generate an image with enhanced sharpness. Here, the image processor 540 may determine a weight of a gain for each pixel, determine a modified gain that reflects the weight, and apply the modified gain to the edge area. The weight of the gain for each pixel may be determined by referring to the similarity between each pixel included in the edge area and adjacent pixels. Ultimately, the modified gain is determined by referring to the similarity between a target pixel and its adjacent pixels.

If the modified gain is not used, the quality of the image may deteriorate because noise contained in the image is amplified by the gain. If the modified gain is used, the quality of the image may be enhanced because only an edge portion is emphasized while the amplification of the noise is prevented.

After the sharpness enhancement is completed, the image processor 540 may remove noise from the image with the enhanced sharpness by using a band-pass filter. Since the band-pass filter removes only noise, the deterioration of the edge portion amplified by the modified gain may not be significant.

The output device 550 may output an image whose sharpness has been enhanced by the image processor 540. For example, the output device 550 may have a communication function to transmit the image with the enhanced sharpness. Alternatively, the output device 550 may have a display function to display the image with the enhanced sharpness.

The controller 530 may perform overall control of the input device 510, the storage 520, the image processor 540, and the output device 550.

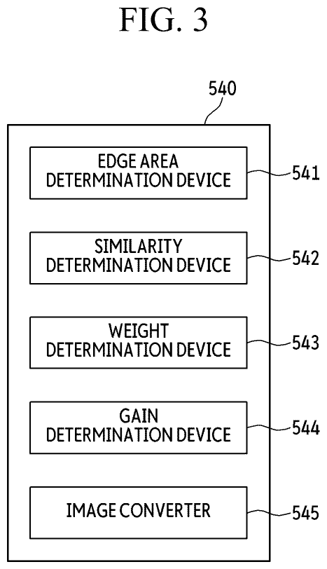

FIG. 3 is a block diagram of the image processor 540 shown in FIG. 2 according to one or more embodiments.

Referring to FIG. 3, the image processor 540 includes an edge area determination device 541, a similarity determination device 542, a weight determination device 543, a gain determination device 544, and an image converter 545.

The edge area determination device 541 may determine an edge area from an image. The image may include various objects and a background. Edges may be formed between the objects and the background, between different objects, and between different patterns. An edge may form a certain area, and this edge area may include a plurality of pixels.

The similarity determination device 542 may determine the similarity between each pixel included in the edge area of the image and adjacent pixels. The similarity between each pixel and the adjacent pixels may be determined using a difference between pixel values of a target central pixel and adjacent pixels. For example, if the difference between the central pixel and the adjacent pixels is large, the similarity may be low, and if the difference between the central pixel and the adjacent pixels is small, the similarity may be high.

The weight determination device 543 may determine a weight for each pixel included in the edge area. Here, the weight is for application to a gain which will be described later. The gain may be modified by the weight to produce a modified gain.

The weight determination device 543 may determine a weight by referring to the similarity determined by the similarity determination device 542. Specifically, the weight of the gain for each pixel may be determined as a larger value as the similarity between each pixel and adjacent pixels increases. High similarity may indicate a small difference between the central pixel and the adjacent pixels, which may indicate that the central pixel is highly unlikely to be noise. On the other hand, low similarity may indicate a large difference between the central pixel and the adjacent pixels, which may indicate that the central pixel is highly likely to be noise. A large weight may be applied to a central pixel with high similarity, and a small weight may be applied to a central pixel with low similarity. In so doing, noise amplification may be prevented.

The gain determination device 544 determines a gain to be applied to each pixel included in the edge area. The gain determination device 544 may determine a modified gain by applying a weight determined by the weight determination device 543 to a reference gain. Here, the reference gain may be a value set in advance (e.g., a preset value) and may be a constant. The gain determination device 544 may determine a modified gain for each pixel included in the edge area. Specifically, the gain determination device 544 may determine the modified gain for each pixel included in the edge area by multiplying the determined weight for each pixel included in the edge area by the reference gain.

The image converter 545 may generate an image with enhanced sharpness by applying the modified gains determined by the gain determination device 544 to the pixels included in the edge area. The pixels included in the edge area may be amplified by the modified gains. Accordingly, the sharpness of the image may be enhanced. Here, since a modified gain for noise has a relatively small value, the amplification of the noise may be prevented.

In addition, the image converter 545 may remove noise from the image with the enhanced sharpness. Specifically, the image converter 545 may remove noise using a band-pass filter. The noise contained in the image with the enhanced sharpness is filtered by the band-pass filter. Finally, an image with enhanced sharpness and noise removed may be generated.

Each component described above with reference to FIGS. 2 and 3 may mean a software or hardware component, such as a Field Programmable Gate Array (FPGA) or Application Specific Integrated Circuit (ASIC). However, the components are not limited to software or hardware components and may be advantageously configured to reside on the addressable storage medium and configured to execute on one or more processors. The functionality provided for in the components may be further separated into additional components or combined into a single component that performs a specific function.

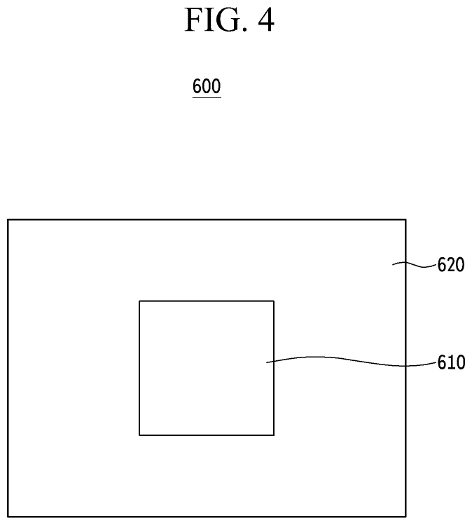

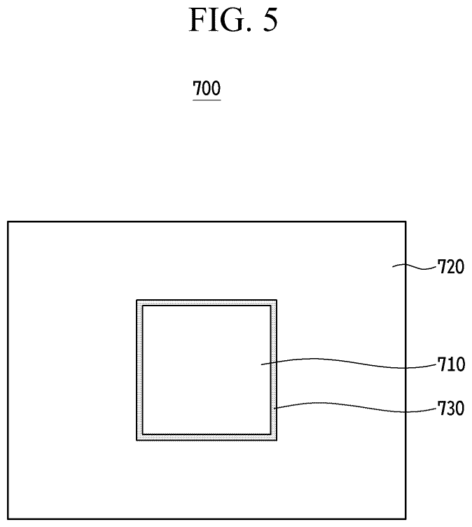

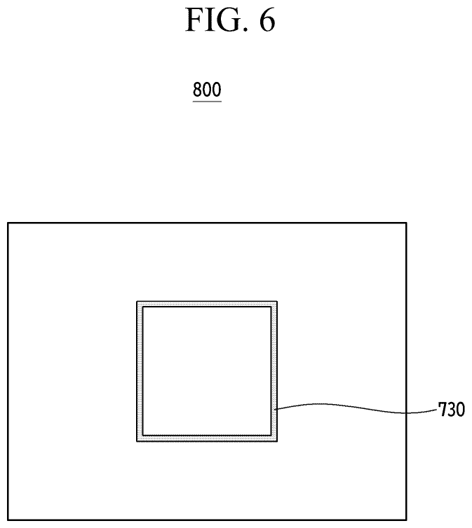

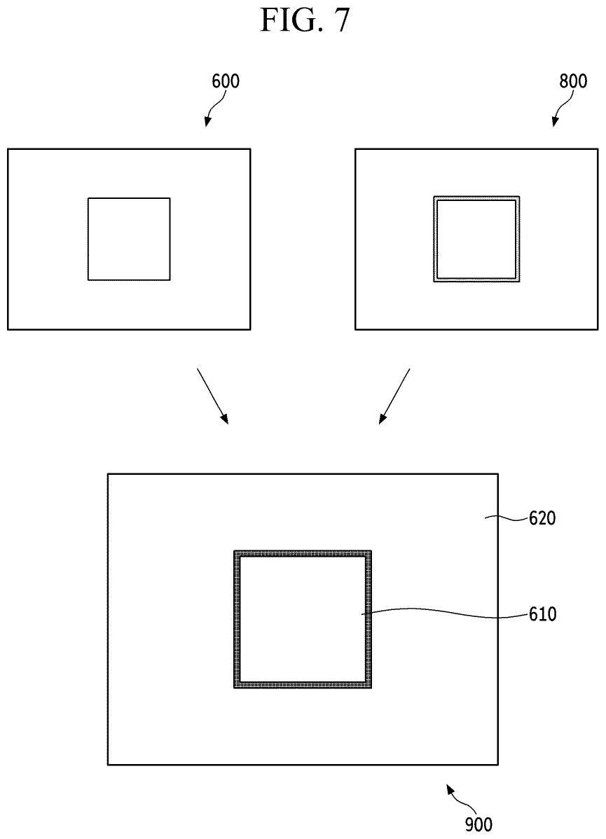

FIG. 4 is a diagram of an image according to one or more embodiments. FIG. 5 is a diagram of a blurred image obtained by blurring the image of FIG. 4 according to one or more embodiments. FIG. 6 is a diagram illustrating a difference between the image of FIG. 4 and the blurred image of FIG. 5 according to one or more embodiments. FIG. 7 is a diagram illustrating the generation of an image with enhanced sharpness according to one or more embodiments.

Referring to FIG. 4, an original image 600 input through the input device 510 may include an object 610 and a background 620. An edge may be formed between the object 610 and the background 620.

Referring to FIG. 5, the edge area determination device 541 may generate a blurred image 700 by blurring the original image 600 in order to determine an edge area. An edge area 730 in which pixel values change rapidly at a boundary between an object 710 and a background 720 in the blurred image 700 may be formed.

Referring to FIG. 6, the edge area determination device 541 may determine the edge area 730 by subtracting the original image 600 from the blurred image 700. Since the blurred image 700 excluding the edge area 730 has similar pixel values to those of the original image 600, when the original image 600 is subtracted from the blurred image 700, an edge image 800 including only the edge area 730 may be generated.

Referring to FIG. 7, the image converter 545 may generate an image 900 with enhanced sharpness by synthesizing the original image 600 and the edge image 800. The image converter 545 may apply a modified gain to each pixel included in the edge area 730. The modified gain may be determined by determining a weight for each pixel included in the edge area 730 and applying the weight for each pixel to the reference gain. The pixels in the edge area 730 corresponding to an area between the object 610 and the background 620 are amplified by the modified gains. Accordingly, a boundary between the object 610 and the background 620 may be clearly observed.

Although the edge area 730 is formed between the object 610 and the background 620 in FIGS. 4 through 7, embodiments are not limited thereto. The edge area 730 may also be formed between areas having different pixel values, such as between different objects 610, between different backgrounds 620, and between different patterns. In addition, the edge area 730 may be formed in a part of an image or in the entire image depending on the complexity of the image.

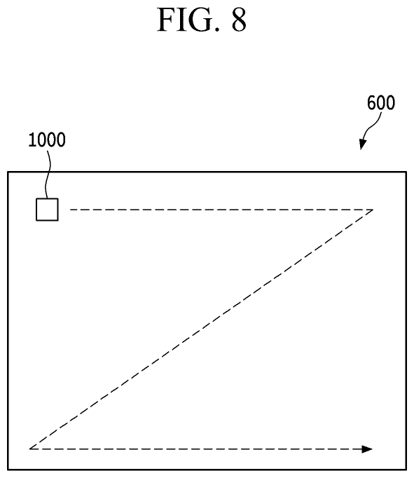

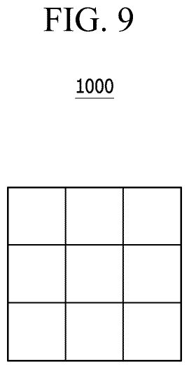

FIG. 8 is a diagram illustrating the scanning of an image using a mask according to one or more embodiments. FIG. 9 is a diagram of a mask according to one or more embodiments.

Referring to FIG. 8, the similarity determination device 542 may determine the similarity of each pixel by scanning the image 600 using a mask 1000.

As shown in FIG. 9, the mask 1000 may be provided in a 3×3 form. A target central pixel may be assigned to a center of the mask 1000, and adjacent pixels may be assigned to an area around the central pixel.

The similarity determination device 542 may determine the similarity of the central pixel by using a difference between the central pixel and the adjacent pixels. The similarity determination device 542 may determine the similarity for all pixels included in the image 600 while scanning the entire image 600 using the mask 1000.

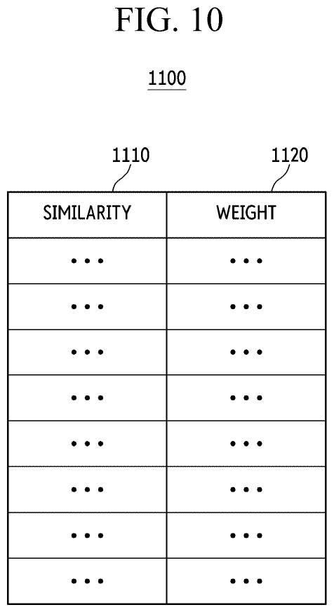

FIG. 10 is a diagram of a weight table according to one or more embodiments.

Referring to FIG. 10, the weight table 1100 may include a similarity field 1110 and a weight field 1120.

The similarity field 1110 may include similarity values, and the weight field 1120 may include weights. The weight table 1100 may include different weights for different similarity values.

The weight determination device 543 may determine a weight of a pixel by referring to the weight table 1100. That is, the weight determination device 543 may apply a similarity value determined by the similarity determination device 542 to the weight table 1100 and determine a weight corresponding to the similarity value.

A weight for each similarity value may be set in advance (e.g., preset values). The weight for each similarity value may be updated as needed.

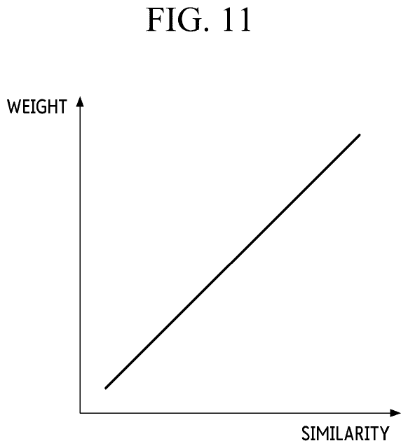

FIG. 11 is a graph illustrating the relationship between similarity and weight according to one or more embodiments.

Referring to FIG. 11, similarity and weight may have a proportional relationship. That is, a weight of a gain for each pixel may be determined as a larger value as the similarity between each pixel and adjacent pixels increases. Accordingly, a weight having a relatively small value may be determined for noise.

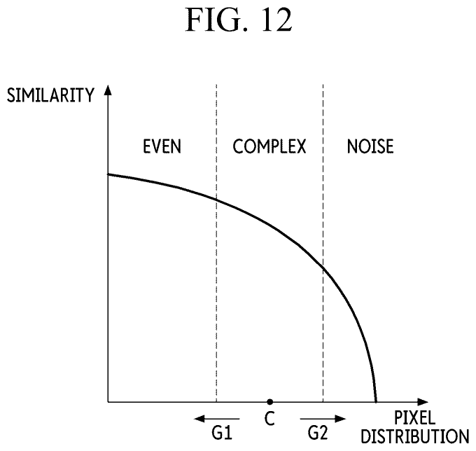

FIG. 12 is a graph illustrating the relationship between pixel distribution and similarity according to one or more embodiments.

Referring to FIG. 12, similarity may be determined according to the distribution of pixels included in the image 600.

The more evenly the pixels are arranged, the higher the similarity, and the more noise the pixels contain, the lower the similarity.

The weight determination device 543 may determine a weight of a gain for each pixel by referring to pixel distribution. The weight of the gain for each pixel may be determined as a larger value as the complexity of a pixel area including the corresponding pixel and its adjacent pixels decreases.

For example, if pixel distribution at a point where a central pixel is located is even, the weight determination device 543 may determine the weight of the gain for each pixel as a large value. If the pixel distribution at the point where the central pixel is located is complex, the weight determination device 543 may determine the weight of the gain for each pixel as a small value. Specifically, the weight determination device 543 may determine the weight by applying a first weight gain to a pixel having lower complexity than a reference complexity and applying a second weight gain to a pixel having higher complexity than the reference complexity. This may be explained by Equation (1) below. Here, the first weight gain may be set to a larger value than the second weight gain.

$$W 1 ( x , y ) = Exp ( S ( x , y ) - C ) \times ( S ( x , y ) - C ) \times G 1 ) W 2 ( x , y ) = Exp ( S ( x , y ) - C ) \times ( S ( x , y ) - C ) \times G 2 ) , \qquad ( 1 )$$

In Equation (1), (x, y) represents coordinates of a pixel, W1 represents a weight (hereinafter, referred to as a first weight) of a pixel having relatively low complexity, W2 represents a weight (hereinafter, referred to as a second weight) of a pixel having relatively high complexity, S represents similarity, C represents reference complexity, G1 represents a first weight gain, and G2 represents a second weight gain.

The first weight may be set to a larger value than the second weight. Accordingly, the amplification of noise contained in the image 600 may be prevented, and only normal edges may be amplified.

The image 900 with enhanced sharpness may be generated using Equation (2).

$$λ ( x , y ) = Max \times W ( x , y ) + Min \times W ( x , y ) Y ( x , y ) = X ( x , y ) + λ ( x , y ) H ( x , y ) , \qquad ( 2 )$$

In Equation (2), (x, y) represents coordinates of a pixel, λ represents a gain, Max represents a maximum gain, Min represents a minimum gain, and W represents a weight. In addition, Y represents the image 900 with enhanced sharpness, X represents the original image 600, and H represents the edge image 800. The maximum gain and the minimum gain may be values set in advance (e.g., a preset value) and may be values set by a user to control the quality of an image. A gain determined by the gain determination device 544 may be determined to be a value included between the maximum gain and the minimum gain.

As described above, the image 900 with enhanced sharpness may be generated by synthesizing the edge image 800, to which a gain has been applied, and the original image 600. Here, the gain refers to a modified gain to which a weight for each pixel has been applied. As the edge image 800 is converted by the modified gain, noise contained in the image is amplified relatively slightly. Therefore, even though the sharpness of the overall image is enhanced, the amplification of the noise may be prevented.

The image processing apparatus and method of the present disclosure described above adjust a weight of a gain for edge sharpening by referring to the similarity between each pixel and its surrounding pixels. Therefore, the image processing apparatus and method have an advantage of improving the sharpness of boundaries while preventing noise amplification.

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An image processing apparatus comprising:
an input device configured to receive an image;
an image processor configured to enhance a sharpness of the image; and
an output device configured to output the image with the enhanced sharpness,
wherein the image processor is further configured to:
determine a weight of a gain for each pixel included in an edge area of the image based on a similarity between each pixel and adjacent pixels; and
apply a modified gain, which reflects the determined weight, to each pixel included in the edge area of the image.

2. The image processing apparatus of claim 1, wherein the weight of the gain for each pixel is determined as a larger value as the similarity between each pixel and the adjacent pixels increases.

3. The image processing apparatus of claim 1, wherein the weight of the gain for each pixel is determined as a larger value as a complexity of a pixel area comprising each pixel and the adjacent pixels decreases.

4. The image processing apparatus of claim 1, wherein the image processor is further configured to remove noise from the image with the enhanced sharpness using a band-pass filter.

5. The image processing apparatus of claim 1, wherein the modified gain is determined by applying the determined weight to a preset reference gain.

6. The image processing apparatus of claim 1, wherein the edge area is determined by subtracting an original image from a blurred image that is obtained by blurring the original image.

7. The image processing apparatus of claim 1, wherein the image processor is further configured to determine the weight of the gain for each pixel based on a pixel distribution.

8. The image processing apparatus of claim 7, wherein the weight of the gain for each pixel is determined as a larger value as a complexity of a pixel area comprising each pixel and the adjacent pixels decreases.

9. An image processing method comprising:
receiving an image;
enhancing a sharpness of the image; and
outputting the image with the enhanced sharpness,
wherein the enhancing of the sharpness of the image comprises:
determining a weight of a gain for each pixel included in an edge area of the image based on a similarity between each pixel and adjacent pixels; and
applying a modified gain, which reflects the determined weight, to each pixel included in the edge area of the image.

10. The image processing method of claim 9, wherein the weight of the gain for each pixel is determined as a larger value as the similarity between each pixel and the adjacent pixels increases.

11. The image processing method of claim 9, wherein the weight of the gain for each pixel is determined as a larger value as a complexity of a pixel area comprising each pixel and the adjacent pixels decreases.

12. The image processing method of claim 9, further comprising removing noise from the image with the enhanced sharpness by using a band-pass filter.

13. The image processing method of claim 9, wherein the modified gain is determined by applying the determined weight to a preset reference gain.

14. The image processing method of claim 9, wherein the edge area is determined by subtracting an original image from a blurred image obtained by blurring the original image.

15. The image processing method of claim 9, wherein the weight of the gain for each pixel is determined based on a pixel distribution.

16. The method of claim 15, wherein the weight of the gain for each pixel is determined as a larger value as a complexity of a pixel area comprising each pixel and the adjacent pixels decreases.
